(19) United States
(12) Patent Application Publication
(10) Pub. No.: US 2025/0390374 A1
(43) Pub. Date: Dec. 25, 2025

(54) INTELLIGENT TRANSFORMER INTEGRATED MANAGEMENT SYSTEM

(71) Applicant: Fortune Electric Co., Ltd., Taoyuan City (TW)

(72) Inventors: CHIA-CHING LIN, Taoyuan City (TW); CHIA-TAI HSU, Taoyuan City (TW); CHAN-EN PEN, Taoyuan City (TW)

(21) Appl. No.: 19/018,301

(22) Filed: Jan. 13, 2025

(30) Foreign Application Priority Data
Jun. 20, 2024 (TW) 113122779

(51) Int. Cl. G06F 11/07

(52) U.S. Cl. CPC G06F 11/079; G06F 11/0715

(57) ABSTRACT

An intelligent transformer integrated management system includes at least one data collection terminal, an analysis and diagnosis management platform, and a maintainer terminal. The at least one detection member of a data detection module of the at least one data collection terminal is configured to obtain operation data. The analysis and diagnosis management platform is communicatively connected to the data detection module of the at least one data collection terminal. The analysis and diagnosis management platform includes a data integration diagnostic device, a maintenance module, a report generation module, a monitoring module, and a record database. The data integration diagnostic device is configured to receive, integrate, and diagnose the operation data of a transformer from the data detection module, and generate a diagnostic result related to health and lifespan of the transformer. The maintainer terminal is communicatively connected to the analysis and diagnosis management platform.

### CROSS-REFERENCE TO RELATED PATENT APPLICATION

This application claims the benefit of priority to Taiwan Patent Application No. 113122779, filed on Jun. 20, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an integrated management system, and more particularly to an intelligent transformer integrated management system.

### BACKGROUND OF THE DISCLOSURE

In power systems, transformers are important apparatuses for power conversion and communication. Electric power provided from a power plant needs to pass through various step-down or step-up transformers before being transmitted to the user. Failure or damage of the transformer apparatuses may lead to fire or explosion, further causing public safety issues. Therefore, maintaining the stability of the transformer and replacing the transformer early before its service lifespan is over are very important issues.

Existing systems have been able to perform intelligent diagnosis for transformers and identify whether or not abnormalities have occurred in transformers. However, the systems in the existing technology are unable to provide immediate analysis of abnormalities of the transformers and immediately notify the user. At the same time, the systems in the existing technology are unable to provide, through integrated management, complete transformer information and transformer lifespan prediction and other complete information about the transformer for the user.

### SUMMARY OF THE DISCLOSURE

In response to the above-referenced technical inadequacies, the present disclosure provides an intelligent transformer integrated management system to effectively integrate states of a transformer, such that a user is able to obtain an operating state of the transformer, comprehensive evaluation information of the transformer, and a maintenance progress of the transformer.

In order to solve the above-mentioned problems, one of the technical aspects adopted by the present disclosure is to provide an intelligent transformer integrated management system. The intelligent transformer integrated management system includes at least one data collection terminal, an analysis and diagnosis management platform, and at least one maintainer terminal. The at least one data collection terminal includes a data detection module. The data detection module has at least one detection member disposed on a transformer. The at least one detection member is configured to obtain at least one piece of operation data. The analysis and diagnosis management platform is communicatively connected to the data detection module of the at least one data collection terminal. The analysis and diagnosis management platform includes a data integration diagnostic device, a maintenance module, a report generation module, a monitoring module, and a record database. The data integration diagnostic device is configured to receive, integrate, and diagnose the at least one piece of operation data of the transformer from the data detection module, and generate at least one diagnostic result related to health and lifespan of the transformer. The maintenance module is configured to receive and integrate the at least one diagnostic result of the diagnostic device according to the data to generate a maintenance notification. The report generation module is configured to receive and analyze the at least one piece of operation data and the at least one diagnostic result to generate at least one comprehensive evaluation report for the transformer. The at least one comprehensive evaluation report is selected from the group consisting of a monitoring analysis report, an overload warning report, a three-phase imbalance state report, a lifespan prediction report, and a maintenance recommendation report. The monitoring module includes a real-time monitoring and display interface. The real-time monitoring and display interface is configured to receive and display the at least one piece of operation data of the transformer. The record database is configured to receive and store the at least one comprehensive evaluation report and the at least one piece of operation data of the transformer to allow at least one user to query. The at least one maintainer terminal is communicatively connected to the analysis and diagnosis management platform. The at least one maintainer terminal is configured to receive the maintenance notification and transmit at least one maintenance record to the record database of the analysis and diagnosis management platform for storage.

In one of the possible or preferred embodiments, the intelligent transformer integrated management system further includes at least one user terminal. The at least one user terminal is communicatively connected to the analysis and diagnosis management platform. The at least one user terminal is configured to set a diagnostic condition of the data integration diagnostic device, receive the maintenance notification and the at least one comprehensive evaluation report, and consult the record database through the analysis and diagnosis management platform.

In one of the possible or preferred embodiments, the diagnostic condition of the data integration diagnostic device includes at least one preset warning value and at least one filtering value range.

In one of the possible or preferred embodiments, when the at least one piece of operation data of the transformer reaches a corresponding one of the at least one preset warning value, the data integration diagnostic device diagnoses that the transformer is in an overload state and generates an overload warning notification that is sent to the at least one user terminal, the at least one maintainer terminal, and the report generation module through the analysis and diagnosis management platform. The report generation module generates the overload warning report based on the overload warning notification and transmits the overload warning report to the at least one user terminal and the record database.

In one of the possible or preferred embodiments, after the at least one maintainer terminal receives the overload warning notification, the at least one maintainer terminal generates an overload description notification and transmits the overload description notification to the record database of the analysis and diagnosis management platform to allow the at least one user to query.

In one of the possible or preferred embodiments, the at least one data collection terminal further includes a temporary storage database configured to temporarily store the at least one piece of operation data of the transformer. The report generation module of the analysis and diagnosis management platform generates a transformer historical analysis report based on the at least one piece of operation data in the temporary storage database of the at least one data collection terminal.

In one of the possible or preferred embodiments, the report generation module of the analysis and diagnosis management platform generates a transformer historical analysis report based on the at least one piece of operation data of the transformer in the record database.

In one of the possible or preferred embodiments, the at least one piece of operation data obtained by the data detection module includes an insulating oil temperature, an insulating paper moisture content, and an insulating paper tensile strength. The data integration diagnostic device predicts a remaining lifespan of the transformer and generates at least one diagnosis result, and the report generation module generates a lifespan prediction report of the transformer and transmits the lifespan prediction report to the at least one user terminal and the record database.

In one of the possible or preferred embodiments, when the data integration diagnostic device analyzes that a three-phase imbalance rate of the transformer is greater than 25%, the data integration diagnostic device generates at least one diagnosis indicating that the transformer is in a three-phase imbalance state, and the report generating module generates a three-phase imbalance warning report of the transformer and transmits the three-phase imbalance warning report to the at least one user terminal and the record database.

In one of the possible or preferred embodiments, the monitoring analysis report includes a hotspot analysis, an oil and gas diagnostic analysis, and an insulating paper moisture content analysis.

In one of the possible or preferred embodiments, the at least one piece of operation data of the transformer is updated every 5 minutes to 15 minutes.

Therefore, in the intelligent transformer integrated management system provided by the present disclosure, by virtue of “a data integration diagnostic device being configured to receive, integrate, and diagnose the at least one piece of operation data of the transformer from the data detection module, and generate at least one diagnostic result related to health and lifespan of the transformer,” and “a report generation module being configured to receive and analyze the at least one piece of operation data and the at least one diagnostic result to generate at least one comprehensive evaluation report for the transformer,” states of a transformer can be effectively integrated, such that a user is able to obtain an operating state of the transformer, comprehensive evaluation information of the transformer, and a maintenance progress of the transformer.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a structure of an intelligent transformer integrated management system according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

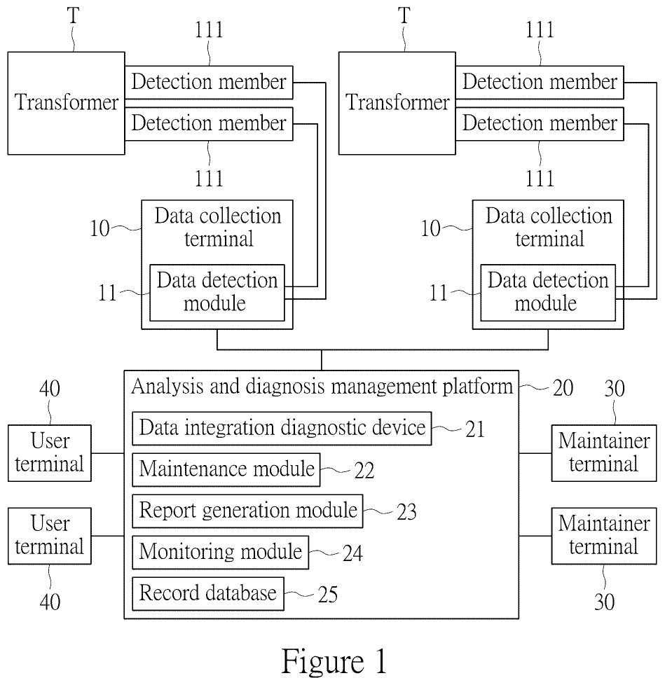

Referring to FIG. 1, one embodiment of the present disclosure provides an intelligent transformer integrated management system. The intelligent transformer integrated management system at least includes: at least one data collection terminal 10, an analysis and diagnosis management platform 20, and at least one maintainer terminal 30. In this embodiment, the intelligent transformer integrated management system further includes at least one user terminal 40. The analysis and diagnosis management platform 20 is communicatively connected to the at least one data collection terminal 10, the at least one maintainer terminal 30, and the at least one user terminal 40 through the Internet. The at least one data collection terminal 10 includes a data detection module 11 having at least one detection member 111 disposed on a transformer T. The analysis and diagnosis management platform 20 includes a data integration diagnostic device 21, a maintenance module 22, a report generation module 23, a monitoring module 24, and a record database 25.

In detail, the at least one detection member 111 is configured to obtain at least one piece of operation data of the transformer T. The analysis and diagnosis management platform 20 is communicatively connected to the data detection module 11 of the at least one data collection terminal 10. Furthermore, the analysis and diagnosis management platform 20 can read or receive the at least one piece of operation data of the transformer T from the data detection module 11 of the at least one data collection terminal 10. In certain embodiments, the at least one data collection terminal 10 is plural in quantity (i.e., a plurality of the data collection terminals 10 are provided). Each of the data collection terminals 10 belongs to a corresponding transformer T, and transmits the at least one piece of operation data of the transformer T to which each of the data collection terminals 10 belongs to the analysis and diagnosis management platform 20. In this embodiment, the transformer T is a three-phase transformer. However, the above examples are only one of the possible embodiments and are not intended to limit the present disclosure.

For example, items that the at least one detection member 111 of the data detection module 11 can detect in a transformer may at least include but are not limited to phase voltages, phase currents, an electrical load, an insulating oil temperature, an insulating oil level height, an insulating paper moisture content, an insulating paper tensile strength, a gas pressure, a fan operating state, an ambient temperature, and an ambient relative humidity.

Referring to FIG. 1, the data integration diagnostic device 21 of the analysis and diagnosis management platform 20 is configured to receive, integrate, and diagnose the at least one piece of operation data of the transformer T from the data detection module 11, and generate at least one diagnostic result related to health and lifespan of the transformer T. The maintenance module 22 is configured to receive the at least one diagnostic result of the data integration diagnostic device 21 to generate a maintenance notification based on the at least one diagnostic result. The report generation module 23 is configured to receive and analyze the at least one piece of operation data and the at least one diagnostic result to generate a comprehensive evaluation report for the transformer T. The comprehensive evaluation report may be selected from the group consisting of a monitoring analysis report, an overload warning report, a three-phase imbalance warning report, a lifespan prediction report, and a maintenance recommendation report. The monitoring module 24 includes a real-time monitoring and display interface configured to receive and display the at least one piece of operation data of the transformer T. The record database 25 is configured to receive and store the at least one comprehensive evaluation report and the at least one piece of operation data of the transformer T to allow at least one user to query.

The at least one maintainer terminal 30 is configured to receive the maintenance notification from the maintenance module 22 of the analysis and diagnosis management platform 20 and transmit at least one maintenance record to the record database 25 of the analysis and diagnosis management platform 20 for storage. In certain embodiments, the maintainer terminal 30 may further include a control device disposed on the transformer T, and the control device performs abnormality elimination on the transformer T through notifications from the analysis and diagnosis management platform 20.

The at least one user terminal 40 is configured to set a diagnostic condition of the data integration diagnostic device 21 through the analysis and diagnosis management platform 20, receive the maintenance notification and the at least one comprehensive evaluation report, and consult the record database 25. In detail, the diagnostic condition of the data integration diagnostic device 21 includes at least one preset warning value and at least one filtering value range. Specifically, in order to prevent error signals caused by surges or signal interferences, when the detected operation data exceeds the filtering value range, the data will be removed to maintain the authenticity of the operation data.

It should be noted that the intelligent transformer integrated management system of the present disclosure can store detailed specifications of the transformer T beforehand to establish a history of multiple ones of the transformer T in the analysis and diagnosis management platform 20. Various integrated management functions provided by the intelligent transformer integrated management system of the present disclosure will be described in detail below.

### (1) Real-Time Monitoring of Transformer and Monitoring Analysis

The at least one piece of operation data of the transformer T can be displayed through the real-time monitoring and display interface of the monitoring module 24 for viewing by the at least one user. Specifically, the at least one piece of operation data of the transformer T is updated every 5 minutes to 15 minutes. That is, the real-time monitoring and display interface updates the at least one piece of operation data of the transformer T every 5 minutes to 15 minutes. In addition, the user can select or set items of the operation data to be displayed on the real-time monitoring and display interface through the user terminal 40. Furthermore, by receiving and analyzing the at least one piece of operation data and a diagnosis result of the data integration diagnostic device 21, the report generation module 23 can generate a monitoring analysis report according to the need of the user. Here, the monitoring analysis report can include but is not limited to a hotspot analysis, an oil and gas diagnostic analysis, and an insulating paper moisture content analysis.

### (2) Overload Warning Processing

The data integration diagnostic device 21 can diagnose whether or not the transformer T is overloaded based on the at least one piece of operation data of the transformer T. Therefore, when the at least one piece of operation data of the transformer T reaches a corresponding preset warning value, the data integration diagnostic device 21 provides the diagnosis result indicating that the transformer T is in an overload state, and generates an overload warning notification. Then, the analysis and diagnosis management platform 20 transmits the overload warning notification to the at least one user terminal 40, the at least one maintainer terminal 30, and the report generation module 23. The report generation module 23 generates an overload warning report based on the overload warning notification, and transmits the overload warning report to the at least one user terminal 40 and the record database 25. For example, the preset warning value may include a first warning value and a second warning value (also known as an upper limit warning value). The real-time monitoring and display interface of the monitoring module 24 includes lights indicating the operating state of the transformer T. For example, a green light indicates that the transformer T is in a normal operation state, a yellow light indicates that abnormalities are present in the transformer T but the transformer T can still operate, and a red light indicates that the abnormalities are present in the transformer T and the transformer T needs to stop operating. When the detected operation data exceeds the first warning value, the overload warning notification generated by the data diagnostic device 21 can be further transmitted to the real-time monitoring and display interface of the monitoring module 24, a color of numerals displayed for the detected operation data is changed from black to red, and an operating state light of the transformer T on the real-time monitoring and display interface switches from green to yellow. When the detected operation data exceeds the second warning value, the overload warning notification generated by the data diagnostic device 21 is transmitted to the real-time monitoring and display interface of the monitoring module 24, the numerals displayed for the detected operation data is displayed in red, and the operating state light of the transformer T on the real-time monitoring and display interface switches from yellow to red. In some other embodiments, after the at least one maintainer terminal 30 receives the overload warning notification, the at least one maintainer terminal 30 generates an overload description notification and transmits the overload description notification to the record database 25 of the analysis and diagnosis management platform 20, and allows the at least one user to query through the at least one user terminal 40. Here, the overload description notification may be generated by at least one maintenance personnel responsible for maintaining the transformer T.

### (3) Transformer Lifespan Prediction

When items of the at least one piece of operation data obtained by the data detection module 11 of at least one data collection terminal 10 include an insulating oil temperature, an insulating paper moisture content, and an insulating paper tensile strength, the data integration diagnostic device 21 can produce the diagnosis result from predicting a remaining lifespan of the transformer T based on the above-mentioned items of the operation data, and the report generation module 23 generates a lifespan prediction report of the transformer T, and transmits the lifespan prediction report to the at least one user terminal 40 and the record database 25.

### (4) Transformer Maintenance Recommendations

The data integration diagnostic device 21 can diagnose the diagnosis results related to the maintenance recommendations of the transformer T based on the at least one piece of operation data obtained by the data detection module 11 of the at least one data collection terminal 10, and the report generation module 23 generates a maintenance recommendation report of the transformer T and transmits the maintenance recommendation report to the at least one user terminal 40 and the record database 25. In addition, after receiving the diagnosis result from the data integration diagnostic device 21, the maintenance module 22 generates a maintenance notification and transmits the maintenance notification to the at least one user terminal 40. In certain embodiments, the maintenance notification generated by the maintenance module 22 can be further sent to the record database 25 or the at least one maintainer terminal 30.

### (5) Three-Phase Imbalance Warning Processing

The load and analysis results of each phase are calculated by monitoring a three-phase voltage and a current of the transformer T, and then recommended adjustments are provided. The results displayed in a report are the latest analysis results. In the report, “voltage” and “current” are both captured and introduced from the record database 25. Normally, a three-phase load and a three-phase current of the transformer T should not differ from each other by more than 25%. When the transformer T is in a three-phase imbalance state during operation, the efficiency of the transformer T will be reduced, the temperature of the transformer T will rise, and the service lifespan of the transformer T will be shortened. Therefore, when the data integration diagnostic device 21 analyzes that a three-phase imbalance rate of the transformer T is greater than 25%, the data integration diagnostic device 21 will diagnose the diagnosis result indicating that the transformer T is in a three-phase imbalance state, and the report generation module 23 generates a three-phase imbalance warning report of the transformer T and transmits the three-phase imbalance warning report to the at least one user terminal 40 and the record database 25 to enable the user terminal 40 to perform recommended adjustments. In detail, the imbalance rate of each phase of the transformer T is a current of any phase subtracting an average current of the three phases and divided by the average current of the three phases, and the three-phase imbalance rate is a maximum value of the imbalance rate of each phase subtracting a minimum value of the imbalance rate of each phase.

### (6) Transformer Historical Analysis

In the intelligent transformer integrated management system of the present disclosure, the report generation module 23 can further extract the operation data of the transformer T stored in the record database 25, and generate a transformer historical analysis report according to the needs of the user. In other embodiments, the data collection terminal 10 may further include a temporary storage database. The temporary storage database is configured to temporarily store the operation data of the transformer T. Here, the report generation module 23 can extract the operation data in the temporary storage database to generate the transformer historical analysis report.

The intelligent transformer integrated management system of the present disclosure can integrate the above-mentioned multiple functions and produce a comprehensive evaluation report of the transformer T according to the needs of the user.

### Beneficial Effects of the Embodiments

One of the beneficial effects of the present disclosure is that, in the intelligent transformer integrated management system provided by the present disclosure, by virtue of “a data integration diagnostic device being configured to receive, integrate, and diagnose the at least one piece of operation data of the transformer from the data detection module, and generate at least one diagnostic result related to health and lifespan of the transformer,” and “a report generation module being configured to receive and analyze the at least one piece of operation data and the at least one diagnostic result to generate at least one comprehensive evaluation report for the transformer,” states of a transformer can be effectively integrated, such that a user is able to obtain an operating state of the transformer, comprehensive evaluation information of the transformer, and a maintenance progress of the transformer.

Furthermore, the data integration diagnostic device can accurately predict a remaining lifespan of the transformer T based on the insulating oil temperature, the insulating paper moisture content, and the insulating paper tensile strength of the transformer. The report generation module then generates a lifespan prediction report for the transformer.

The intelligent transformer integrated management system of the present disclosure integrates management of transformers and provides real-time electronic reports to users. In addition, the maintenance progress and records of maintenance personnel can also be provided to users for direct inquiry through the intelligent transformer integrated management system of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An intelligent transformer integrated management system, comprising:
at least one data collection terminal including a data detection module having at least one detection member disposed on a transformer, wherein the at least one detection member is configured to obtain at least one piece of operation data of the transformer;
an analysis and diagnosis management platform communicatively connected to the data detection module of the at least one data collection terminal, wherein the analysis and diagnosis management platform includes:
a data integration diagnostic device configured to receive, integrate, and diagnose the at least one piece of operation data of the transformer from the data detection module, and generate at least one diagnostic result related to health and lifespan of the transformer;
a maintenance module configured to receive the at least one diagnostic result of the data integration diagnostic device to generate a maintenance notification based on the at least one diagnostic result;
a report generation module configured to receive and analyze the at least one piece of operation data and the at least one diagnostic result to generate at least one comprehensive evaluation report for the transformer, wherein the at least one comprehensive evaluation report is selected from the group consisting of a monitoring analysis report, an overload warning report, a three-phase imbalance state report, a lifespan prediction report, and a maintenance recommendation report;
a monitoring module including a real-time monitoring and display interface configured to receive and display the at least one piece of operation data of the transformer; and
a record database configured to receive and store the at least one comprehensive evaluation report and the at least one piece of operation data of the transformer to allow at least one user to query; and
at least one maintainer terminal communicatively connected to the analysis and diagnosis management platform, wherein the at least one maintainer terminal is configured to receive the maintenance notification and transmit at least one maintenance record to the record database of the analysis and diagnosis management platform for storage.

2. The intelligent transformer integrated management system according to claim 1, further comprising at least one user terminal communicatively connected to the analysis and diagnosis management platform, wherein the at least one user terminal is configured to set a diagnostic condition of the data integration diagnostic device, receive the maintenance notification and the at least one comprehensive evaluation report, and consult the record database through the analysis and diagnosis management platform.

3. The intelligent transformer integrated management system according to claim 2, wherein the diagnostic condition of the data integration diagnostic device includes at least one preset warning value and at least one filtering value range.

4. The intelligent transformer integrated management system according to claim 3, wherein, when the at least one piece of operation data of the transformer reaches a corresponding one of the at least one preset warning value, the data integration diagnostic device diagnoses that the transformer is in an overload state and generates an overload warning notification that is sent to the at least one user terminal, the at least one maintainer terminal, and the report generation module through the analysis and diagnosis management platform; wherein the report generation module generates the overload warning report based on the overload warning notification and transmits the overload warning report to the at least one user terminal and the record database.

5. The intelligent transformer integrated management system according to claim 4, wherein, after the at least one maintainer terminal receives the overload warning notification, the at least one maintainer terminal generates an overload description notification and transmits the overload description notification to the record database of the analysis and diagnosis management platform to allow the at least one user to query.

6. The intelligent transformer integrated management system according to claim 1, wherein the at least one data collection terminal further includes a temporary storage database configured to temporarily store the at least one piece of operation data of the transformer; wherein the report generation module of the analysis and diagnosis management platform generates a transformer historical analysis report based on the at least one piece of operation data in the temporary storage database of the at least one data collection terminal.

7. The intelligent transformer integrated management system according to claim 1, wherein the report generation module of the analysis and diagnosis management platform generates a transformer historical analysis report based on the at least one piece of operation data of the transformer in the record database.

8. The intelligent transformer integrated management system according to claim 2, wherein the at least one piece of operation data obtained by the data detection module includes an insulating oil temperature, an insulating paper moisture content, and an insulating paper tensile strength; wherein the data integration diagnostic device predicts a remaining lifespan of the transformer and generates at least one diagnosis result, and the report generation module generates a lifespan prediction report of the transformer and transmits the lifespan prediction report to the at least one user terminal and the record database.

9. The intelligent transformer integrated management system according to claim 2, wherein, when the data integration diagnostic device analyzes that a three-phase imbalance rate of the transformer is greater than 25%, the data integration diagnostic device generates at least one diagnosis indicating that the transformer is in a three-phase imbalance state, and the report generating module generates a three-phase imbalance warning report of the transformer and transmits the three-phase imbalance warning report to the at least one user terminal and the record database.

10. The intelligent transformer integrated management system according to claim 1, wherein the monitoring analysis report includes a hotspot analysis, an oil and gas diagnostic analysis, and an insulating paper moisture content analysis.

11. The intelligent transformer integrated management system according to claim 1, wherein the at least one piece of operation data of the transformer is updated every 5 minutes to 15 minutes.
